(19) United States
(12) Patent Application Publication
(10) Pub. No.: US 2017/0206204 A1
(43) Pub. Date: Jul. 20, 2017

(54) SYSTEM, METHOD, AND DEVICE FOR GENERATING A GEOGRAPHIC AREA HEAT MAP

(71) Applicant: Alibaba Group Holding Limited, Grand Cayman (KY)

(72) Inventor: Luokai XIONG, Hangzhou (CN)

(21) Appl. No.: 15/409,660

(22) Filed: Jan. 19, 2017

(30) Foreign Application Priority Data
Jan. 20, 2016 (CN) 201610038914.6

(51) Int. Cl. G06F 17/30; G06N 99/00; G06K 9/62; H04L 29/08; G06K 9/20

(52) U.S. Cl. CPC G06F 17/30061; H04L 67/18; G06K 9/2081; G06K 9/6212; G06F 17/30241; G06N 99/005

(57) ABSTRACT

Embodiments of the disclosure provide a method and apparatus for generating a geographic area heat map. In one embodiment, the method comprises: receiving linked data from one or more users, the linked data including service feature data associated with the one or more users and location service data associated with the one or more users; extracting candidate users from the one or more users based on the linked data and a geographic area to be identified; determining a user distribution density based on the linked data, wherein the user distribution density include a total number of the candidate users in the geographical area to be identified; and displaying the user distribution density of the geographical area to be identified.

### CROSS-REFERENCE TO RELATED APPLICATIONS

This application claims the benefit of priority of Chinese Application No. 201610038914.6, titled “A Method and Apparatus for Geographic Area Heat Map Representation,” filed on Jan. 20, 2016, which is hereby incorporated by reference in its entirety.

### FIELD OF THE DISCLOSURE

The disclosure relates to the technical field of data processing, and in particular to systems, methods and devices for generating a geographic area heat map.

### DESCRIPTION OF RELATED ART

The processing and application of data are important topics in current computer technologies. Currently, the most representative application is in the field of cloud computing services, where cloud services implement data mining with big data to provide in-depth applications of the mined data.

Using data-driven site selection as an example, when a merchant selects a site for a shop, the merchant often desires knowledge of population flow of a business district or area as well as the population structure of the district or area. Cloud applications determine, by analyzing big data, whether an area meets the merchant's requirements for opening a shop.

Existing shop site selection methods that utilize population flow estimation for a preselected area require many on-the-spot investigations. Population flow data at different time frames is obtained by means of investigating and recording. Specifically, current techniques for investigating the population flow include recordation of flow data at various periods of time and for identified age categories. For example, the key periods of time for a convenience store are a first period (07:00-09:00), a second period (11:00-13:00), a third period (17:00-19:00), and fourth period (21:00-23:00). Likewise, age categories may be divided into ages of 7-13, 13-17, and 17-40. An average value of the population flow data during these four periods of time on weekdays and the four most recent holidays may be used as a reference for selecting a site.

According to current techniques, although population flow and population distribution of an area may be analyzed, a large amount of human resources must be consumed and interest feature data (e.g., demographic information, user interests, etc.) of investigated people cannot be incorporated, despite interest feature data considerably influencing the opening of a shop. For example, if it is known that a large portion of investigated people own pets, this would have a direct impact on the opening of a pet shop. In addition, if the population flow and population structure of the area are investigated in a short period of time, the obtained result may not be representative of all situations. Moreover, manually investigated areas are necessarily limited and cannot cover every business district or all demographic information of each area. Therefore, data acquisition and processing and applications of data are important projects to this day.

### BRIEF SUMMARY

Regarding the foregoing problems, systems, methods, and devices for generating geographic area heat map are disclosed so as to resolve, or at least partly resolve, the foregoing problems.

In one embodiment, the disclosure describes a method for generating a geographic area heat map. The method comprises receiving linked data from one or more users, the linked data including service feature data associated with the one or more users and location service data associated with the one or more users; extracting candidate users from the one or more users based on the linked data and a geographic area to be identified; determining a user distribution density based on the linked data, wherein the user distribution density includes a total number of the candidate users in the geographical area to be identified; and displaying the user distribution density of the geographical area to be identified.

In another embodiment, the disclosure describes an apparatus for generating a geographic area heat map. The apparatus comprises one or more processors and a non-transitory memory storing computer-executable instructions therein that, when executed by the processor, cause the apparatus to receive linked data from one or more users, the linked data including service feature data associated with the one or more users and location service data associated with the one or more users; extract candidate users from the one or more users based on the linked data and a geographic area to be identified; determine a user distribution density based on the linked data, wherein the user distribution density include a total number of the candidate users in the geographical area to be identified; and display the user distribution density of the geographical area to be identified.

It should be noted that service feature data of a user according to one embodiment of the disclosure may be collected via an e-commerce platform. Therefore, work of manually investigating and observing a population flow of a specific area may be avoided. Location service data of the user may be collected through a mobile terminal. Because the mobile terminal may be carried by the user, location service data of the user, for example, a longitude and latitude at which the user is located, may be automatically collected. With respect to other devices, a mobile terminal has obvious advantages of being portable and comprehensive.

### BRIEF DESCRIPTION OF THE DRAWINGS

FIG. 1 is a flow diagram illustrating a method for generating a geographic area heat map according to some embodiments of the disclosure.

FIG. 2 is a schematic diagram of a shop site selection process based on a large amount of user data according to some embodiments of the disclosure.

FIG. 3 is a schematic diagram of a shop site selection process based on a large amount of user data according to some embodiments of the disclosure.

FIG. 4 is a flow diagram illustrating a method for generating a geographic area heat map according to some embodiments of the disclosure.

FIG. 5 is a process diagram illustrating the querying of user distribution density by a terminal according to some embodiments of the disclosure.

FIG. 6 is an illustration of a heat map representing a user distribution density in a map according to some embodiments of the disclosure.

FIG. 7 is a block diagram of a device for generating a geographic area heat map according some embodiments of the disclosure.

FIG. 8 is a block diagram of a device for generating a geographic area heat map according some embodiments of the disclosure.

### DETAILED DESCRIPTION

The described drawings herein are used for providing further understanding for the disclosure and constitute a portion of the application. Exemplary embodiments and descriptions thereof of the disclosure intend to explain the disclosure rather than improperly limiting the disclosure.

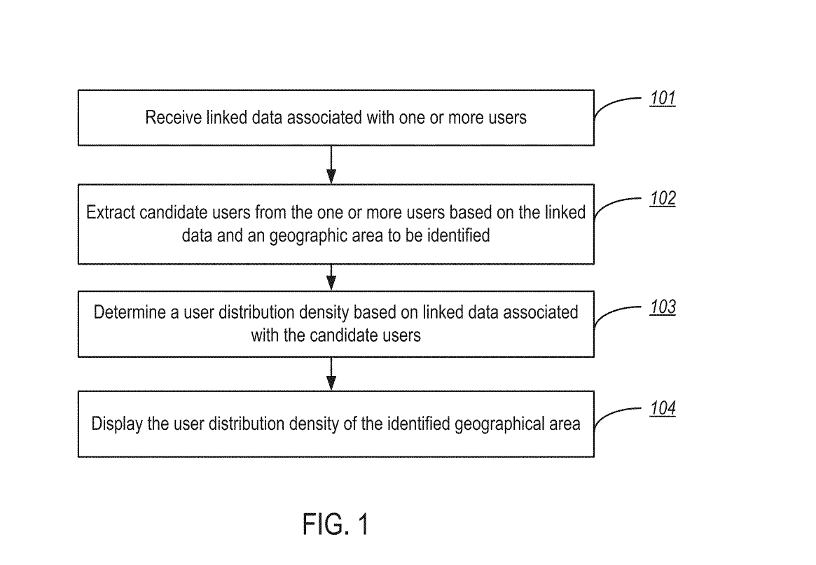

FIG. 1 is a flow diagram illustrating a method for generating a geographic area heat map according to some embodiments of the disclosure.

In some embodiments, the method illustrated in FIG. 1 determines multiple “visiting conditions” of users of a specified geographic area by using large amounts of related data which represent both basic information and an “interest feature” of a user. As will be described, the method provides related information regarding a specified geographic area. Applications of the illustrated method are described below using the example of a merchant selecting a location for a shop. These examples should not be construed as limiting the scope of the embodiments.

In step 101, the method receives linked data associated with one or more users. As described in more detail herein, linked data may comprise a combination of service feature data and location service data. In one embodiment, service feature data may comprise data relating to online services accessed by a user and location service data may comprise data relating to locations visited by a user.

Receiving linked data may include the following sub-steps.

In sub-step S11, the method receives service feature data from the one or more users. In one embodiment, service feature data may include data representing basic service feature data of basic information of each user and behavioral service feature data of an interest feature of each user. As a non-limiting example, basic service feature data may comprise data representing the age, hobbies, height, predicted career, and the like of a user.

In some embodiments, sub-step S11 may include the following sub-steps.

In sub-step S11-11, the method may receive service data of the one or more users collected by a service platform, where the service data includes basic service feature data and behavioral service data.

In sub-step S11-12, the method may generate behavioral service feature data based on the behavioral service data of the one or more users.

In sub-step S11-13, the method may combine the basic service feature data and the behavioral service feature data as the service feature data of the one or more users.

In some embodiments, the service platform may be an e-commerce platform, and basic service feature data of a user and behavioral service data of the user (e.g., collection, purchase, clicking, and searching) are stored at a data center using a data acquisition system of the e-commerce platform. This data may be divided, according to one or more dimensions, into a user behavioral information datacenter and a basic user information datacenter.

In one embodiment, the behavioral service data may be further processed according to preset rules, so as to obtain behavioral service feature data which can reflect an interest feature of the user.

In one embodiment, sub-step S11-12 may include the following sub-steps.

In sub-step S11-12-11, the method may obtain a weight by training preset service feature data based on the behavioral service feature data of the one or more users.

In sub-step S11-12-12, the method may then use the preset service feature data having a weight greater than a value of a preset factor as the behavioral service feature data of the one or more users.

In one embodiment, based on behavioral service data of a user, first behavioral service feature data of the user is formulated. Data modeling may then be performed using logistic regression so as to extract a weight corresponding to the behavioral service feature data of each user. Finally, whether the behavioral service feature data can serve as the behavioral service feature data which reflects an interest feature of the user is determined according to the weight.

Logistic regression is a common machine learning method and is used to estimate a possibility of an event, for example, a possibility that a user purchases a commodity, a possibility that a patient suffers from an illness, and a possibility that an advertisement is clicked by a user. It should be noted that the foregoing “possibility” is not the “probability” in mathematics; and a result of the logistic regression is not a probability value in a mathematical definition, and therefore cannot be directly used as a probability value.

Specifically, regarding preset behavioral service feature data, training is performed based on the behavioral service feature data of each user according to a logistic regression model so as to obtain a weight corresponding to each behavioral service feature data. Next, the behavioral service feature data of the user is sequenced according to the weight, and behavioral service feature data having a weight greater than a specific factor value to serve as the behavioral service feature data of the user is screened.

It should be noted that when implementing embodiments of the disclosure, other data models and other manners may also be used to obtain the behavioral service feature data of the user. Any specific examples are not intended to limit the embodiments of the disclosure.

In one embodiment, according to service feature data to be saved to a datacenter, a user profile table having a user identifier (for example, a user ID) as a primary key may be stored.

A user profile table contains basic service feature data of the user (for example, age and gender) and further contains behavioral service feature data of the user (for example, information such as height, weight, and a predicted carrier). In addition, the user profile table further contains information of related dimensions that reflect a consumption habit and an interest feature of the user, for example, information such as a prediction about whether the user owns a pet, a prediction about whether the user loves sports, a consumption level of the user, and a predicted income level.

Certainly, it should be noted that the basic service feature data is not clearly distinguished from the behavioral service feature data, and the two may overlap; or the behavioral service feature data is obtained by eliminating the basic service feature data from the service feature data, and training the behavioral service data; this is not limited in the embodiments of the disclosure.

In sub-step S12, the method may receive location service data from the one or more users. In one embodiment, the sub-step S12 may include receiving location service data of the one or more users collected by a mobile terminal.

In some embodiments, the mobile terminal is a handheld device which can be carried by a user (for example, a smart phone). Therefore, according to one embodiment of the disclosure, Location Based Service (“LBS”) data of a user may be collected with a data acquisition module of a mobile terminal so as to form LBS data, i.e., location service data, related to the user and saved to a specified database.

Specifically, a data table in a database which saves the user LBS data may use a user ID as a primary key, and correspondingly saves content of the user such as a longitude, a latitude, a Point of Interest (“POI”), and an acquisition time.

It should be noted that the LBS data is collected by an application in which location service data is regularly collected by a mobile device or a mobile network phone terminal and therefore, on this basis, the data is provided (for example, a navigation system). According to one embodiment, the location service data can better express a query intention of the user, and therefore, analyzing and guessing a POI of the user by using the location service data can effectively avoid unnecessary operations, so as to shorten an operation time of a query. In some embodiments, if content expected by the user can be accurately estimated, limitations brought by a screen size are reduced.

Currently, an example which is associated with LBS data and is widely used is a Geographic Information System (“GIS”). Data in a GIS represents an entity in reality. A location based service needs more information, in addition to objective spatial data saved in a GIS, to provide better services for the user. Therefore, a concept of user POI needs to be introduced in a GIS. Each POI indicates a point within a geographical area which is useful to the user or can make the user be interest, and often is represented by a longitude and latitude. Therefore, according to one embodiment of the disclosure, on the basis of the location service data collected by a mobile terminal, a longitude and latitude at which the user is located can be obtained.

In sub-step S13, the method may link the service feature data and the location service data according to the one or more users so as to obtain the linked data.

In one embodiment, the service feature data and the location service data separately have a corresponding user identifier; and step S13 may include merging the service feature data and the location service data according to the one or more users having the same user identifier as the linked data.

In one embodiment, an associative relationship between the service feature data and the LBS data of the user may be established according to the user ID. For example, data tables respectively corresponding to the service feature data and the LBS data that have the same user ID may be joined so as to obtain an intersection between the service feature data and the LBS data, that is, the linked data between the service feature data and the LBS data.

In step 102, the method extracts, based on the linked data of the one or more users, candidate users from the one or more users based on a geographic area to be identified.

In one embodiment, the step 102 may include the following sub-steps.

In sub-step S21, the method receives and uses a geographical area selected by a user in preset map data as the geographical area to be identified.

In sub-step S22, the method receives a feature screening condition submitted by the user.

In sub-step S23, the method identifies, based on the location service data of the one or more users, users within the geographical area to be identified, and identifies users of which the service feature data can meet the feature screening condition to serve as the candidate users.

In one embodiment, a geographical area selected by a user in preset map data may be used as the geographical area to be identified and then candidate users satisfying a condition are further located in the geographical area to be identified based on the feature screening condition submitted by the user.

In one embodiment, sub-step S21 may include the following sub-steps.

In sub-step S21-11, the method receives a longitude and latitude, and a radius inputted by the user.

In sub-step S21-12, the method circles a geographical area in the preset map data based on the longitude and latitude, and the radius.

In sub-step S21-13, the method uses the geographical area as the geographical area to be identified.

In one embodiment, sub-step S21-11 includes the following sub-step.

In sub-step S21-11-11, the method receives a POI and the radius inputted by the user, where the POI has a corresponding longitude and latitude.

In one embodiment, the location service data may include a longitude and latitude corresponding to the user and the sub-step S23 may include the following sub-steps.

In sub-step S23-11, the method identifies the longitude and latitude in the location service data within the geographical area to be identified. In sub-step S23-12, the method selects users corresponding to the longitude and latitude as the candidate users. In sub-step S23-13, the method locates users, among the candidate users, of which the service feature data matches the feature screening condition. In sub-step S23-14, the method determines the users matching the feature screening condition as the candidate users.

In one embodiment, the geographical area to be identified may be an area within which a merchant is considering opening a shop.

Using a merchant selecting an area for opening a shop as an example, assuming that a merchant circles an area within which a shop is expected to be opened, the area for opening a shop is circled by inputting a specific POI and radius, or is circled based on a specific longitude, latitude, and radius. An operation of circling or otherwise delimiting a geographic area our bounded region may be intuitively performed by the user on a map via a user interface. The area for opening a shop that is provided by the merchant is a screening condition for further querying underlying data.

After the area for opening a shop is determined, the merchant selects, according to a type of the shop to be opened, a population of the service feature data matching the shop type and the service feature data of the population that is inputted by the merchant is a screening condition for querying the underlying data. Additionally, the merchant may further input a specified period to serve as a screening condition for querying.

In one embodiment, consecutive time data may be input so as to display a visiting condition by the population during a period of the area for opening a shop.

It should be noted that the merchant may input one or more query conditions and the number of conditions is not limited in the embodiments of the disclosure.

In step 103, the method determines a user distribution density based on the linked data associated with the candidate users.

In one embodiment, user distribution density can reflect user distribution conditions of a geographical area. Specifically, the user distribution density includes a specific value of a quantity of users for a geographical area and a value of a user quantity of the area that meets a specified condition. In addition, the user distribution density may further include parameters that can reflect other related information of the geographical area, for example, information such as a POI, and a longitude and latitude value of the geographical area.

In one embodiment, the user distribution density includes a longitude and latitude for each of the candidate users and step 103 may further include extracting, from the linked data, a longitude and latitude corresponding to a user identifier present in the candidate users.

In one embodiment, a queried data packet contains a POI, a longitude and latitude value, a count value of the geographical area (e.g., a specific value of a user quantity that is contained in an area of this longitude and latitude), and similar metrics. A heat map may be drawn based on this information (e.g., the heat map may be drawn based on a map API plugin of a preset map). The heat map is composed of a longitude and latitude, and a population count value, and can reflect a density degree of a specified population of the area by using a color brightness or other contrasting visual representation.

In step 104, the method displays the user distribution density of the geographic area to be identified.

In one embodiment, step 104 may further include displaying the user distribution density of the geographic area to be identified in the preset map data.

In one embodiment, the obtained user distribution density (e.g., a POI, a longitude and latitude value, and a count value of the geographical area) may be input in a preset map based on a map API plugin, and then may reflect the user distribution density in a mode of a heat map. Therefore, a user, as a merchant, can intuitively understand the population distribution condition of the geographical area to be identified.

In one embodiment, there may be a plurality of geographic areas to be identified, and the method may further comprise marking respectively the geographic areas to be identified with different colors in the preset map data.

In some embodiments, when a plurality of geographic areas to be identified are needed, the geographic areas to be respectively identified may be marked with different colors, or be marked with different deep and light colors. This is not limited in the embodiments of the disclosure.

In one embodiment, according to the obtained service feature data and the location service data of the one or more users, the service feature data and the location service data are associated according to the user so as to obtain the linked data, and then the candidate users for the geographical area to be identified are determined based on the linked data, and the user distribution density are obtained based on the linked data corresponding to the candidate users. The user distribution density can reflect a user quantity in the geographical area to be identified.

In one embodiment, a user may input a feature screening condition, locate, in the linked data corresponding to the candidate users, users corresponding to service feature data matching the feature screening condition, and then obtain the user distribution density based on the linked data corresponding to the users. The user distribution density obtained at this time can reflect a user quantity in the geographical area to be identified that meet the feature screening condition. This embodiment of the disclosure may provide, for example, for shop site selection of a merchant, a user quantity meeting the shop type in an area in which the merchant expects to open a shop. Thus, the merchant may determine whether a shop can be opened in the area, or whether a shop needs to be opened, thereby providing the merchant with good experience effects.

In one embodiment, for obtaining the user distribution density, a user quantity of each geographical area may be presented to the merchant in a form of a heat map by means of inputting into a corresponding map with a map plugin, thereby bringing in better query experience and visual effects for a user.

Using a merchant selecting an area for opening a shop as an example, the merchant selecting an area for opening a shop may be briefly summarized to include the following steps:

1. obtain service feature data of a user by collecting service data of the user on an e-commerce platform, so as to categorize the user according to an interest feature;

2. according to location service information of the user that is collected by a mobile terminal, represent the user having the corresponding service feature data at a map; and

3. according to user distribution on a map, instruct an off-line shop site selection of a merchant further based on population densities and distribution features during different periods and of different populations with specific characteristics.

To enable a person skilled in the art to better understand the disclosed embodiments, the embodiments are described below using the example of a merchant selecting an area for opening a shop.

Specifically, in some embodiments, service feature data of the users is extracted based on service data of many e-commerce users, and LBS data of users having specified service feature data are represented at the same time with a heat map.

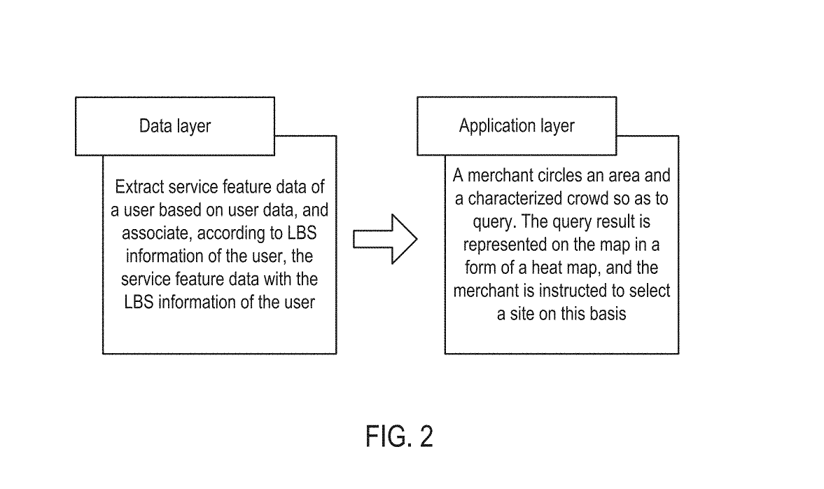

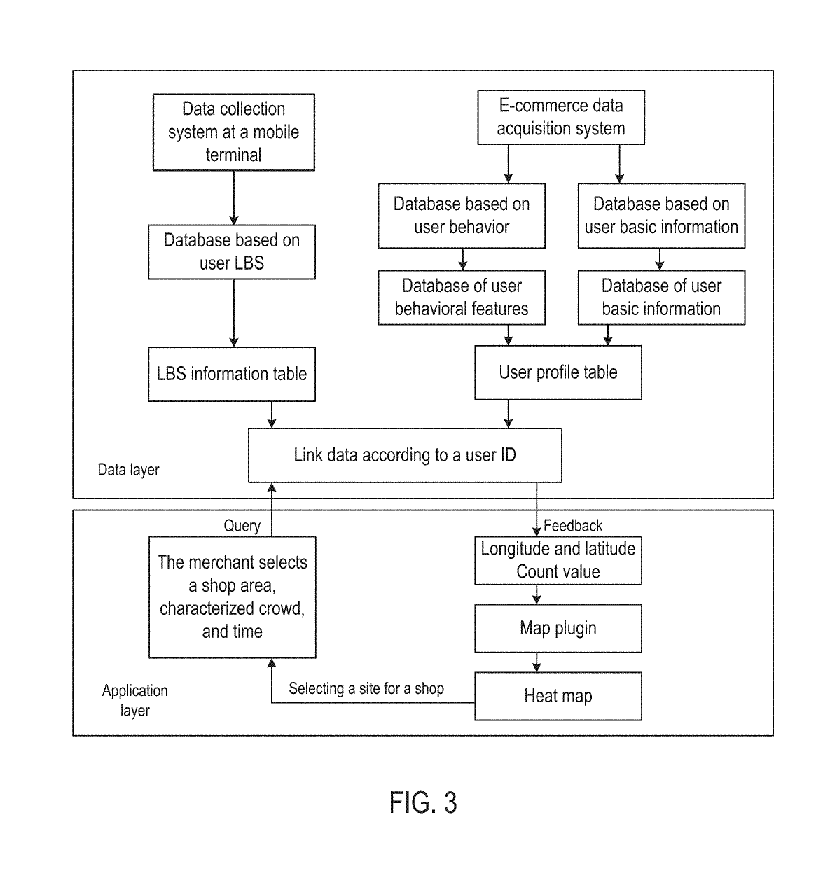

With reference to the diagram of a shop site selection process based on a large amount of user data according to the disclosure as shown in FIG. 2 and FIG. 3, it can be known from FIG. 2 that the process has two core processing parts: the first part is, at a data layer, extracting service feature data for a large amount of users, and associating service feature data of the users and LBS data of the users; and the second part is, at an application layer, representing users having different service features on a map in a mode of a heat map.

In this example, a shop site selection method based on a large amount of e-commerce user data and LBS data specifically includes the following steps:

I. Processing at a data layer, linking large of e-commerce user data and LBS data:

a) Storing, with a data acquisition system of an e-commerce platform, basic service feature information of a user, and behavioral service data such as collection, purchase, clicking, and locating to a specified datacenter. This data is divided, according to a dimension, into a user behavioral information based datacenter and a user basic information based datacenter.

b) Extracting a weight of the behavioral service feature data of each user, based on behavioral service data of the user, by first formulating preset behavioral service feature data of the user, and performing data modeling with a logistic regression.

c) Sequencing weights of the behavioral service feature data, and screening a feature having a weight greater than a specific factor value to serve as the behavioral service feature data of the user, so as to indicate an interest feature of the user. In one embodiment, according to the service feature data, a user profile table using a user ID as a primary key may be formed and may be saved in a datacenter. The user profile table contains basic feature information of the user, for example, age and gender; and further contains behavioral service feature data, for example, information such as height, weight, and a predicted carrier. In addition, the user profile table also contains information of related dimensions of a consumption habit and an interest feature of the user, for example, prediction about whether the user owns a pet, prediction about whether the user loves sports, a consumption level, and a predicted income level, etc.

d) Collecting LBS data of the user based on a data acquisition module of a mobile terminal so as to form a database containing the LBS information of the user. An LBS information table of the user uses a user ID as a primary key, and may specifically include information such as a longitude, a latitude, a POI, and an acquisition time.

e) Connecting the service feature data and the LBS data of the user according to the user ID. Two data tables are joined to associate the service feature data and the LBS data of the user.

II. Processing at an application layer, establishing a web service about a map:

a) A merchant circles an area within which a shop is expected to be opened, where the area is circled by using specific POI and radius, or is circled based on a specific longitude, latitude, and radius. The operation may be intuitively performed on a map. Area information provided by the merchant is serving as a screening condition for querying underlying data.

b) According to a type of the shop to be opened, the merchant circles a population corresponding to the service feature data that matches the shop type. A feature of the population circled by the merchant is serving as a screening condition for querying the underlying data. Meanwhile, the merchant may use data such as a specified period to serve as a screening condition for querying.

c) Querying in the linked data by using the foregoing screening condition in a) and b), where queried data may specifically include a POI, a longitude and latitude value, and a count value (a specific quantity of people that is contained in an area of this longitude and latitude). A heat map may be drawn by using this data (the heat map may be drawn by using a map API plugin of a map application or software). The heat map is composed of information about the longitude and the latitude, and a population count value. A density degree of a specified population of the area is reflected based on a color brightness or different colors of the heat map.

d) The merchant selects a site for a shop according to the population information provided by a system. For example, if an owner mainly sells sports brands, according to several areas which are pre-selected to open a shop, the owner first circles an area by using longitude and latitude, or the POI and the radius and then circles the population by using the service feature data (for example, circling a consumer group at ages 18-24 or 25-29 that is considered to be most relevant by a merchant). As a result, the population may be represented on a map in a mode of a heat map by inputting corresponding age group information on the map and then clicking a query service on the map. The merchant may compare color brightness or colors of several different candidate areas, and may select, according to a population density in the candidate areas that satisfies a product orientation of the merchant, an area of a high population density to be a preferred area for opening a shop.

Embodiments of the disclosure creatively provide instructing work of an off-line shop site selection based on behavioral data of large of on-line users, thereby saving work of manually investigating and observing a population flow of a specific area. In addition, a population with specific characteristics may further be represented on a map in a mode of a heat map. Therefore, the merchant can intuitively understand a distribution of populations having different service features in the specific area selected by the merchant.

The embodiments of the disclosure disclosed above may be implemented at a cloud server of an e-commerce platform. In alternative embodiments, portions of the disclosure may also be partly executed at a mobile terminal and be partly executed at a cloud server. However, relatively speaking, related data of a user is preferably to be collectively processed by a cloud server, so as to improve data processing efficiency.

A cloud server according to one embodiment of the disclosure may further have a content pushing function. For example, after representing a heat map for a merchant, the cloud server may further push, according to a user distribution density, information for the merchant information matching the user distribution density . For example, assuming that there are 200 people of features that meet a condition for opening a shop, and requirements for opening a shop are satisfied, a selected site at which a shop can be opened may be prompted.

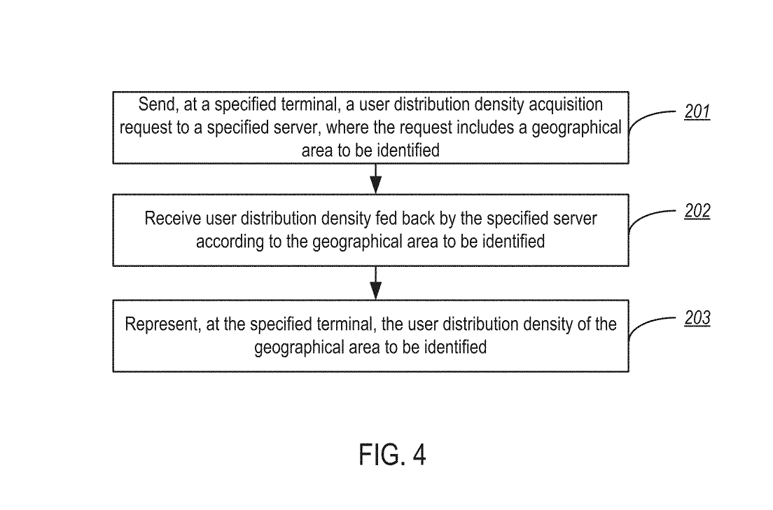

FIG. 4 is a flow diagram illustrating a method for representing geographic area heat map according to some embodiments of the disclosure.

In step 201, the method sends, at a specified terminal, a user distribution density acquisition request to a specified server, where the request includes a geographical area to be identified.

In some embodiments, the specified server collects linked data of one or more users. Specifically, the linked data includes service feature data and location service data corresponding to the one or more users. The location service data includes a longitude and latitude.

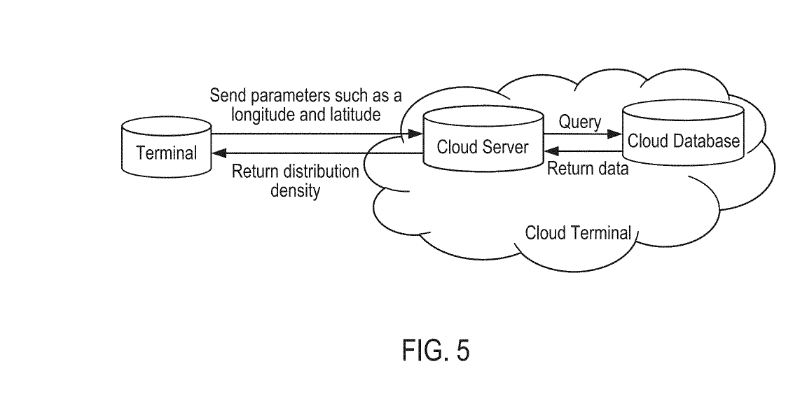

As illustrated in FIG. 5, a user may want to know whether a geographical area is suitable for opening a shop, so the user inputs a longitude and latitude (or a POI) by using a terminal and sends an acquisition request carrying the longitude and latitude (or the POI) to a specified server specified by a cloud service provider. The specified server determines, in preset map data, a geographical area to be identified according to the longitude and latitude (or POI).

In step 202, the method receives the user distribution density fed back by the specified server according to the geographical area to be identified.

After the server determines the geographical area to be identified, a user distribution density within the geographical area to be identified are obtained and fed back to the corresponding terminal. The user distribution density may include a count value of the geographical area, a POI, and a longitude and latitude value.

Returning to FIG. 4, in one embodiment, the request may include service feature data; and step 202 may further include receiving the user distribution density fed back by the specified server according to the geographical area to be identified and the service feature data.

Further, when submitting the acquisition request, service feature data which can reflect an interest feature and/or basic information of the user may also be submitted at the same time, so as to serve as a feature screening condition. The server obtains a user distribution density according to the service feature data and the geographical area to be identified. The user distribution density includes a count value, a POI, and a longitude and latitude value of the geographical area, and a number of users meeting the service feature data.

In step 203, the method represents, at the specified terminal, the user distribution density of the geographical area to be identified.

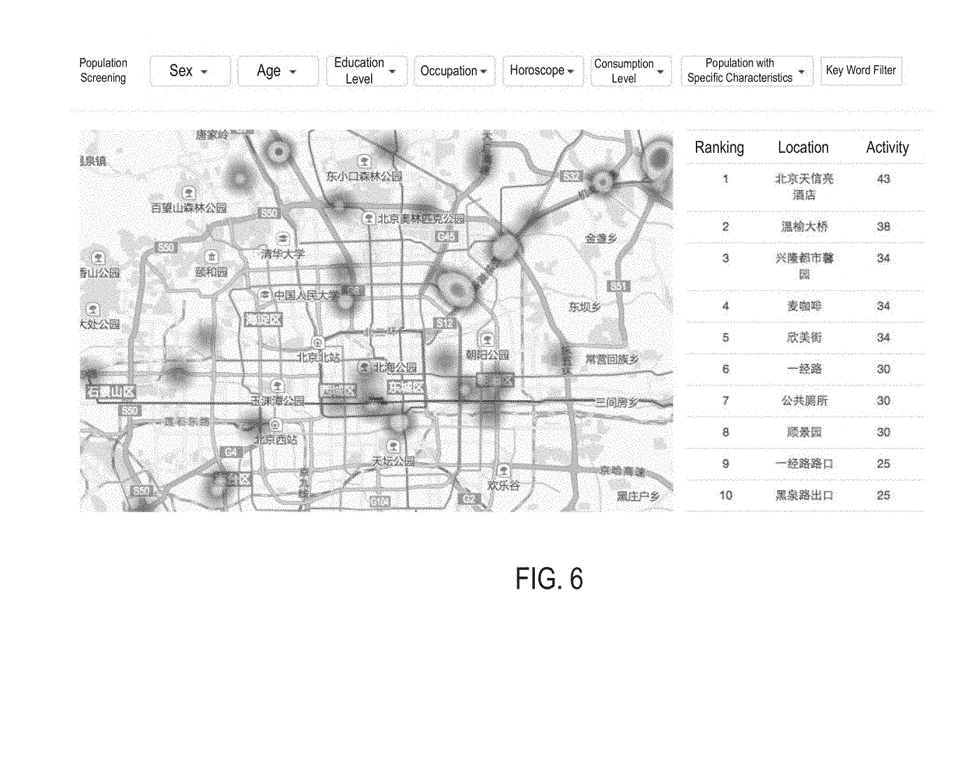

FIG. 6 is an illustration of a heat map representing a user distribution density in a map according to some embodiments of the disclosure.

As illustrated in FIG. 6, when a user distribution density is obtained by a server, the user distribution density may be sent and be displayed at a specified terminal in as a heat map. Therefore, the user can intuitively understand a user distribution condition of the geographical area to be identified that satisfies the requirements.

As illustrated in FIG. 6, there are several geographical areas to be identified on the map. In order to facilitate a merchant to input, a population screening condition may be selected by the user in one or more dropdown menus. When the merchant determines population screening conditions such as gender, age, and educational background, the server calculates the user distribution density according to the population screening conditions, and represents the user distribution density in a map in a mode of a heat map. To allow the merchant to screen, an activity level which meets the population screening conditions and can reflect each geographical area to be identified can be further obtained according to the user distribution density, providing an improved user experience.

In alternative embodiments, a key word may be input to serve as a population screening condition, thereby more accurately circling a population.

As illustrated above, a user can obtain a user distribution density of a geographical area to be identified. According to the user distribution density, the user can determine a user distribution condition of the geographical area to be identified and can determine a user distribution condition meeting the condition of the geographical area to be identified.

Using a merchant selecting a new shop address as an example, by using the described embodiments, a user quantity meeting the shop type in an area in which the merchant expects to open a shop can be provided. Accordingly, the merchant may determine whether a shop can be opened in the geographical area, or whether a shop needs to be opened, thereby providing the merchant with reliable population metrics.

For the sake of clarity, the previously described method embodiments are described as a series of combinations of actions. However, a person skilled in the art would understand that embodiments of the disclosure are not limited by a sequence of the described actions as some steps may be implemented in other sequences or be implemented concurrently. Moreover, a person skilled in the art would understand that embodiments described in the description are provided as example embodiments, and the specific actions are not all necessary to the embodiments of the disclosure.

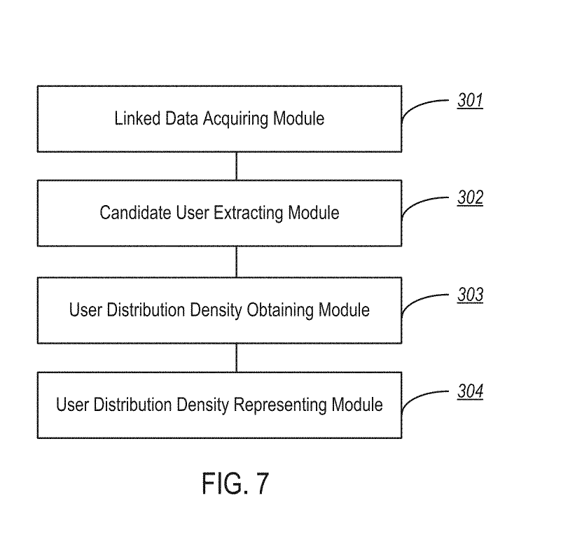

FIG. 7 is a block diagram of a device for generating a geographic area heat map according some embodiments of the disclosure.

The device includes a linked data acquiring module 301 configured to a receive linked data from one or more users. In one embodiment, the linked data acquiring module 301 may include the following sub-modules.

(1) A service feature data acquiring sub-module configured to receive service feature data from the one or more users.

In one embodiment, the service feature data acquiring sub-module may include the following units: a service feature data acquiring unit configured to receive service data of the one or more users collected by a service platform, wherein the service data includes basic service feature data and behavioral service data; a behavioral service feature data generating unit configured to generate behavioral service feature data based on the behavioral service data of the one or more users; and a service feature data organization unit configured to organize the basic service feature data and the behavioral service feature data as the service feature data of the one or more users.

In one embodiment, the behavioral service feature data generating unit may include the following sub-units: a service feature data weight obtaining sub-unit configured to train preset service feature data based on the behavioral service feature data of the one or more users so as to obtain a weight; and a behavioral service feature data determining sub-unit configured to use the preset service feature data having a weight greater than a value of a preset factor as the behavioral service feature data of the one or more users.

(2) A location service data acquiring sub-module configured to receive location service data from the one or more users.

In one embodiment, the location service data acquiring sub-module may include a location service data acquiring unit configured to acquire the location service data of the one or more users collected by a mobile terminal.

(3) A linked data obtaining sub-module configured to link the service feature data and the location service data according to the one or more users so as to obtain the linked data.

In one embodiment, the service feature data and the location service data separately have a corresponding user identifier; and the linked data acquiring module 301 may include a data merging unit configured to merge the service feature data and the location service data having the same user identifier as the linked data.

The device further includes a candidate user extracting module 302 configured to extract, based on the linked data of the one or more users, candidate users according to a geographic area to be identified.

In one embodiment, the candidate user extracting module 302 may include the following sub-modules: a geographical area to be identified selecting sub-module configured to use a geographical area selected by a user in preset map data as the geographical area to be identified; a feature screening condition receiving sub-module configured to receive a feature screening condition submitted by the user; and a candidate user locating sub-module configured to locate, based on the location service data of the one or more users, users within the geographical area to be identified, and locate users of which the service feature data can meet the feature screening condition to serve as the candidate users.

In one embodiment, the geographical area to be identified selecting sub-module may include the following units: a longitude and latitude, and radius receiving unit configured to receive a longitude and latitude, and a radius inputted by the user; a geographical area circling unit configured to circle a geographical area in the present map data based on the longitude and latitude, and the radius; and a geographical area to be identified determining unit configured to use the geographical area as the geographical area to be identified.

In one embodiment, the longitude and latitude, and radius receiving unit may include a POI and radius receiving sub-unit configured to receive a POI and the radius inputted by the user, where the POI has a corresponding longitude and latitude.

In one embodiment, the location service data may include a longitude and latitude corresponding to the user; and the candidate user locating sub-module may include the following sub-modules: a longitude and latitude locating unit configured to locate the longitude and latitude in the location service data within the geographical area to be identified; a candidate user determining unit configured to use users corresponding to the longitude and latitude as the candidate users; a matching user locating unit configured to locate users, among the candidate users, of which the service feature data matches the feature screening condition; and a candidate user determining unit configured to determine the users matching the feature screening condition as the candidate users.

The device further includes a user distribution density obtaining module 303 configured to determine a user distribution density based on the linked data associated with the candidate users.

In one embodiment, the user distribution density includes a longitude and latitude of the candidate users; and the user distribution density obtaining module 303 may include a longitude and latitude extracting sub-module configured to extract, from the linked data, a longitude and latitude corresponding to the user identifier of the candidate users.

The device further includes a user distribution density representing module 304 configured to represent the user distribution density of the geographic area to be identified.

In one embodiment, the user distribution density representing module 304 may include a heat map representing sub-module configured to represent, in the preset map data, the user distribution density of the geographic area to be identified.

In one embodiment, there are a plurality of geographic areas to be identified and the device may further include a distribution density color marking module configured to mark respectively, in the preset map data, the geographic areas to be identified with different colors.

In one embodiment, the service platform may be an e-commerce platform; the mobile terminal may be a smart phone; and the user distribution density may include a specific user quantity of the geographical area to be identified.

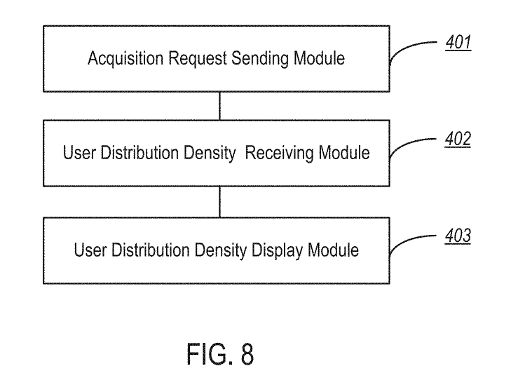

FIG. 8 is a block diagram of a device for generating a geographic area heat map according some embodiments of the disclosure.

The device includes an acquisition request sending module 401 configured to send a user distribution density acquisition request to a specified server, where the request includes a geographical area to be identified.

The device includes a user distribution density receiving module 402 configured to receive the user distribution density fed back by the specified server according to the geographical area to be identified.

In one embodiment, the request may further include service feature data and the user distribution density receiving module 402 may include a user distribution density receiving sub-module configured to receive the user distribution density fed back by the specified server according to the geographical area to be identified and the service feature data.

The device includes a user distribution density display module 403 configured to represent, at the specified terminal, the user distribution density of the geographical area to be identified.

The device embodiments are substantially similar to the method embodiments and therefore are only briefly described, and reference may be made to the method embodiments for the associated part.

The embodiments in this specification are all described in a progressive manner. Description of each of the embodiments focuses on differences from other embodiments, and reference may be made to each other for the same or similar parts among respective embodiments.

A person skilled in the art should understand that the embodiments of the disclosure may be provided as a method, a device, or a computer program product. Therefore, the embodiments of the disclosure may use a form of a hardware embodiment, an entire software embodiment, or an embodiment combining software and hardware. In addition, the embodiments of the disclosure may use a form of a computer program product implemented on one or more computer available storage media (including, but not limited to a magnetic disk storage, a CD-ROM, or an optical memory) including a computer available program code.

In a typical configuration, a computer device includes one or more processors (CPU), an input/output interface, a network interface, and a memory. The memory may include modes such as a volatile memory in computer readable media, a random access memory (RAM), and/or a non-volatile memory, for example, a read-only memory (ROM) or a flash memory (flash RAM). The memory is an example of computer readable media. The computer readable media include permanent and volatile, removable and non-removable media, and can implement information storage with any method or technology. The information may be a computer-readable instruction, a data structure, a program module, or other data. Examples of a computer storage medium include but not limited to a phase-change memory (PRAM), a static random access memory (SRAM), a dynamic random access memory (DRAM), other types of random access memory (RAM), a read-only memory (ROM), an electrically erasable programmable read only memory (EEPROM), a flash memory, or other memory technologies, a compact disc-read only memory (CD-ROM), a digital versatile disc (DVD), or other optical storages and magnetic cassette tapes. Tape storage, disk storage, other magnetic memory devices, or any other non-transmission medium may be used to store information which may be accessed by a computing device. According to a definition in the present text, a computer readable media does not include transitory media (transitory media), such as a modulated data signal or carrier wave.

The embodiments of the disclosure are described with reference to flow diagrams and/or block diagrams of the method, device (system), and the computer program product in the embodiments of the disclosure. It should be understood that computer program instructions can implement each process and/or block in the flow diagrams and/or block diagrams and a combination of processes and/or blocks in the flow diagrams and/or block diagrams. These computer program instructions may be provided to a general-purpose computer, a dedicated computer, an embedded processor, or a processor of another programmable data processing device to generate a machine, so that an apparatus configured to implement functions specified in one or more processes in the flow diagrams and/or one or more blocks in the block diagrams is generated based on instructions executed by the general-purpose computer or the processor of another programmable data processing device.

These computer program instructions may also be stored in a computer readable memory that can guide a computer or another programmable data processing device to work in a specific manner, so that the instructions stored in the computer readable memory generate a product including an instruction apparatus, where the instruction apparatus implements functions specified in one or more processes in the flow diagrams and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more processes in the flow diagrams and/or one or more blocks in the block diagrams.

Although preferable embodiments of the embodiments of the disclosure are described, once a person skilled in the art knows a basic inventive concept, the person skilled in the art can make additional changes and modifications to these embodiments. Therefore, the claims are intended to be explained to include preferable embodiments and all changes and modifications fall within the scope of the embodiments of the disclosure.

Finally, it should be further noted that the relational terms herein, such as first and second, are used only to differentiate an entity or operation from another entity or operation, and do not require or imply any actual relationship or sequence between these entities or operations. Moreover, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element.

The foregoing introduces in detail the method of representing geographic area heat map and the device of representing geographic area heat map that are provided in the disclosure. The disclosure uses specific examples to describe the theory and implementation manners of the disclosure. The foregoing description to the embodiments is merely used to help explain the method and core spirit of the disclosure. Meanwhile, for a person skilled in the art, according to the spirit of the disclosure, changes may be made to the specific implementation manners and the applications of the implementation manners. In summary, content of this specification should not be understood as a limitation to the disclosure.

What is claimed is:

1. A method comprising:
receiving linked data associated with one or more users, the linked data including service feature data associated with the one or more users and location service data associated with the one or more users;
extracting candidate users from the one or more users based on the linked data and a geographic area to be identified;
determining a user distribution density based on linked data associated with the candidate users; and
displaying the user distribution density of the geographical area to be identified.

2. The method of claim 1, wherein receiving linked data further comprises:
receiving service data of the one or more users collected by a service platform, the service data including basic service feature data and behavioral service data;
generating behavioral service feature data based on the behavioral service data; and
combining the basic service feature data and the behavioral service feature data as the service feature data.

3. The method of claim 2, wherein generating behavioral service feature data based on the behavioral service data comprises:
training preset service feature data based on the behavioral service feature data to obtain a weight; and
using the preset service feature data having a weight greater than a preset factor as the behavioral service feature data.

4. The method of claim 1, wherein extracting candidate users comprises:
receiving a geographical area selected by a user as the geographic area to be identified;
receiving a feature screening condition submitted by the user;
identifying, based on the location service data, a first subset of users within the geographic area to be identified;
identifying, based on the service feature data, a second subset of users wherein each user in the second subset of users is associated with service feature data that satisfies the feature screening condition; and
identifying a set of candidate users based on the first and second subset of users.

5. The method of claim 4, wherein receiving a geographical area selected by a user as the geographic area to be identified comprises:
receiving a longitude, latitude, and radius from the user;
identifying a circular a geographical area based on the longitude, latitude, and radius; and
using the circled geographical area as the geographical area to be identified.

6. The method of claim 5, wherein receiving a longitude, latitude, and radius from the user comprises receiving a point of interest and a radius from the user, wherein the point of interest is associated with a longitude and latitude.

7. The method of claim 4 wherein the location service data includes a longitude and latitude associated with each user, wherein identifying, based on the location service data, a first subset of users within the geographic area to be identified comprises:
identifying a longitude and latitude in the location service data within the geographical area to be identified; and
selecting users corresponding to the longitude and latitude as the candidate users.

8. The method of claim 1, wherein the user distribution density includes a longitude and latitude for each of the candidate users, and determining the user distribution density based on the linked data comprises extracting, from the linked data, a longitude and latitude corresponding to a user identifier selected from the candidate users.

9. The method of claim 1, wherein displaying the user distribution density of the geographic area to be identified comprising displaying, in preset map data, the user distribution density of the geographic area to be identified.

10. The method of claim 9, wherein the geographical area to be identified comprises a plurality of geographic areas, and the method further comprises marking respectively, in the preset map data, the plurality of geographic areas with different colors.

11. An apparatus comprising:
one or more processors; and
a non-transitory memory storing computer-executable instructions therein that, when executed by the processor, cause the apparatus to
receive linked data associated with one or more users, the linked data including service feature data associated with the one or more users and location service data associated with the one or more users;
extract candidate users from the one or more users based on the linked data and a geographic area to be identified;
determine a user distribution density based on linked data associated with the candidate users; and
display the user distribution density of the geographical area to be identified.

12. The apparatus of claim 11, wherein the instructions causing the apparatus to receive linked data further include instructions causing the apparatus to:
receive service data of the one or more users collected by a service platform, the service data including basic service feature data and behavioral service data;
generate behavioral service feature data based on the behavioral service data; and
combine the basic service feature data and the behavioral service feature data as the service feature data.

13. The apparatus of claim 12, wherein the instructions causing the apparatus to generate behavioral service feature data based on the behavioral service data further include instructions causing the apparatus to:
train preset service feature data based on the behavioral service feature data to obtain a weight; and
use the preset service feature data having a weight greater than a preset factor as the behavioral service feature data.

14. The apparatus of claim 11, wherein the instructions causing the apparatus to extract candidate users further include instructions causing the apparatus to:
receive a geographical area selected by a user as the geographic area to be identified;
receive a feature screening condition submitted by the user;
identify, based on the location service data, a first subset of users within the geographic area to be identified;
identify, based on the service feature data, a second subset of users wherein each user in the second subset of users is associated with service feature data that satisfies the feature screening condition; and
identify a set of candidate users based on the first and second subset of users.

15. The apparatus of claim 14, wherein the instructions causing the apparatus to receive a geographical area selected by a user as the geographic area to be identified further include instructions causing the apparatus to:
receive a longitude, latitude, and radius from the user;
identify a circular a geographical area based on the longitude, latitude, and radius; and
use the circled geographical area as the geographical area to be identified.

16. The apparatus of claim 15, wherein the instructions causing the apparatus to receive a longitude, latitude, and radius from the user further include instructions causing the apparatus to receive a point of interest and a radius from the user, wherein the point of interest is associated with a longitude and latitude.

17. The apparatus of claim 14 wherein the location service data includes a longitude and latitude associated with each user, wherein the instructions causing the apparatus to identify, based on the location service data, a first subset of users within the geographic area to be identified further include instructions causing the apparatus to:
identify a longitude and latitude in the location service data within the geographical area to be identified; and
select users corresponding to the longitude and latitude as the candidate users.

18. The apparatus of claim 11, wherein the user distribution density includes a longitude and latitude for each of the candidate users, and wherein the instructions causing the apparatus to determine user distribution density based on the linked data further include instructions causing the apparatus to extract, from the linked data, a longitude and latitude corresponding to a user identifier selected from the candidate users.

19. The apparatus of claim 11, wherein the instructions causing the apparatus to display the user distribution density of the geographic area to be identified further include instructions causing the apparatus to display, in preset map data, the user distribution density of the geographic area to be identified.

20. The apparatus of claim 19, wherein the geographical area to be identified comprises a plurality of geographic areas, and the instructions further include instructions causing the apparatus to mark respectively, in the preset map data, the plurality of geographic areas with different colors.
